(19) United States
(12) Patent Application Publication
(10) Pub. No.: US 2005/0152066 A1
(43) Pub. Date: Jul. 14, 2005

(54) System with matrix array of write heads and array of magnetoresistive (MR) read heads

(75) Inventor: Yung Yip, Afton, MN (US)

Correspondence Address: Attention: Eric D. Levinson;Imation Corp, Legal Affairs, P.O. Box 64898, St. Paul, MN, 55164-0898, US

(73) Assignee: Imation Corp.

(21) Appl. No.: 10/755,143

(22) Filed: Jan. 8, 2004

(51) Int. Cl. G11B 5/48

(52) U.S. Cl. 360/241.1

(57) ABSTRACT

The invention provides a system comprising an array of write heads and an array of magnetoresistive (MR) read heads. The array of read heads may comprise a linear array of MR heads, and the array of write heads may comprise a planar array of heads arranged in a two-dimensional matrix. Each channel of the array of write heads has a corresponding channel in the array of read heads. Data signals can be independently written to different tracks of a medium using the array or write heads and can be read using each channel the array or read heads. Moreover, the system can facilitate read and write operations at very small track pitches.

### TECHNICAL FIELD

The invention relates to magnetic data storage media and, more particularly, to magnetic heads for reading and writing data to such media.

### BACKGROUND

Magnetic data storage media are commonly used for storage and retrieval of data, and come in many forms, such as magnetic tape, magnetic disks, and the like. Magnetic tape media remains an economical medium for storing large amounts of data. For example, magnetic tape cartridges, or large spools of magnetic tape are often used to back up large amounts of data for large computing centers. Magnetic tape cartridges also find application in the backup of data stored on smaller computers such as workstations, desktop or laptop computers.

In magnetic tape, data is typically stored as magnetic signals that are magnetically recorded on the medium surface. The data stored on the magnetic tape is often organized along data tracks, and read/write heads are positioned relative to the data tracks to write data to the tracks or read data from the tracks. As the number of data tracks increases, the data storage capacity of the magnetic tape likewise increases. However, as the number of data tracks increases, the tracks usually become narrower and more crowded on the surface of the data storage tape. Servo tracks are also commonly defined on magnetic media to provide reference points for tracking the location of data tracks.

A wide variety of heads have been designed: to write data to magnetic media. Various heads have also been designed to read data stored on magnetic media. A magnetic data storage system often includes both write heads and read heads to facilitate the writing of information to the magnetic medium and readout of such information.

### SUMMARY

In general, the invention provides a system for recording data to magnetic media and reading data from such media. The system utilizes a matrix array of write heads and an array of read heads. Each channel of the array of write heads has a corresponding channel in the array or read heads. Distinct data signals can be written to tracks on a medium using channels of the matrix array of write heads, and can be read using respective channels of the array of read heads. The matrix array of write heads may comprise a planar array, and the array of read heads may comprise a linear array of magnetoresistive (MR) heads.

In one embodiment, the invention provides a system for reading and writing information to magnetic media. The system comprises an array of write heads arranged in a two-dimensional matrix, wherein each of the write heads defines a write channel for the system, and an array of MR heads, wherein each of the MR heads defines a read channel for the system.

In another embodiment, the invention provides a system for reading and writing information to magnetic tape. The system comprises a first array of write heads arranged in a two-dimensional matrix, wherein each of the write heads in the first array of write heads defines a write channel for the system in a first tape direction and a second array of write heads arranged in another two-dimensional matrix, wherein each of the write heads in the second array of write heads defines a write channel for the system in a second tape direction. The system also comprises an array of MR heads positioned between the first and second planar arrays, wherein each of the MR heads of the array of MR heads defines a read channel for the system in both the first and second tape directions.

In another embodiment, the invention provides a system for reading and writing information to magnetic tape. The system comprises a first array of MR heads, wherein each of the MR heads in the first array of MR heads defines a read channel for the system in a first tape direction and a second array of M heads, wherein each of the MR heads in the second array of MR heads defines a read channel for the system in a second tape direction. The system also comprises an array of write heads arranged in a two-dimensional matrix and positioned between the first and second arrays of MR heads, wherein each of the write heads defines a write channel for the system in both the first and second tape directions.

In another embodiment, the invention provides a method comprising simultaneously writing information to multiple channels of magnetic tape using a matrix array of write heads, and simultaneously reading the information from the multiple channels of the magnetic tape using a linear array of MR heads.

The invention may be capable of providing one or more advantages. For example, the invention incorporates a linear array of MR heads with a matrix array of write heads to facilitate a system that can operate at improved track pitches relative to conventional read/write systems. In particular, track pitches less than 100 microns, less than 50 microns, or even less than 10 microns can be achieved. Accordingly, the invention can facilitate increased storage densities on magnetic media, and is particularly useful for increasing the storage densities of magnetic tape. A linear array of MR heads may have advantages in terms of quality of readout and ease of manufacture, relative to magneto-optic read heads or other read heads.

Moreover, in some embodiments, the invention provides systems and techniques that allow for bi-directional read/write operations to be executed on magnetic tape. In particular, write operations can be performed simultaneously on multiple magnetic tape tracks, at track pitches less than 100 microns, less than 50 microns, or even less than 10 microns. Then, read operations can be performed simultaneously on the multiple magnetic tape tracks, e.g., to verify the integrity of the information written to the multiple tape tracks.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is perspective view of a system comprising a linear array of magnetoresistive (MR) heads and a planar array of write heads according to an embodiment of the invention.

FIG. 2 is a bottom view of the system illustrated in FIG. 1.

FIG. 3 is another bottom view rendition of the system illustrated in FIG. 1.

FIG. 4 is a block diagram illustrating a portion of a planar array of write heads and a portion of a linear array of MR heads according to an embodiment of the invention.

FIG. 5 is a perspective view of a system comprising a first linear array of MR heads, a second linear array of MR heads, and a planar array of write heads positioned between the first and second linear arrays of M heads according to an embodiment of the invention.

FIG. 6 is a bottom view of the system illustrated in FIG. 5.

FIG. 7 is a perspective view of a system comprising a first planar array of write heads, a second planar array of write heads, and a linear array of MR heads positioned between the first and second planar arrays of write heads according to an embodiment of the invention.

FIG. 8 is a bottom view of the system illustrated in FIG. 7.

FIG. 9 is a flow diagram according to an embodiment of the invention.

### DETAILED DESCRIPTION

The invention provides a system comprising an array of write heads and an array of read heads. The array of read heads may comprise a linear array of magnetoresistive (MR) heads, although the invention is not necessarily limited in that respect. The array of write heads may comprise a planar array of heads arranged in a two-dimensional matrix. Each channel of the array of write heads has a corresponding channel in the array of read heads. Data signals can be independently written to different tracks of a medium using the array of write heads and can be read using each channel of the array or read heads.

Track pitch reductions in flexible magnetic media, in particular, can be limited by head channel pitch of write heads. The size of head coils of write heads, for example, can cause limits in track pitch reductions for some conventional systems. Moreover, dimensional stability of flexible magnetic media can pose substantial problems to track pitch reductions because changes to the media dimensions can cause changes between the locations of tracks before and after the tracks are written. The matrix arrangement of write heads addresses these problems by avoiding limits imposed by head coils. Dimensional stability problems are reduced because dimensional changes to the medium are averaged across the distance spanned by the number of head channel pitches. In a matrix arrangement the head channel pitch is greatly reduced, hence the distance spanned by the head channels is also reduced. Therefore, the system described herein can facilitate read and write operations at very small track pitches. In particular, the head channel pitch between adjacent channels of the planar array or write heads and the head channel between adjacent channels of linear array or read heads may be less than 100 microns, less than 50 microns, or even less than 10 microns.

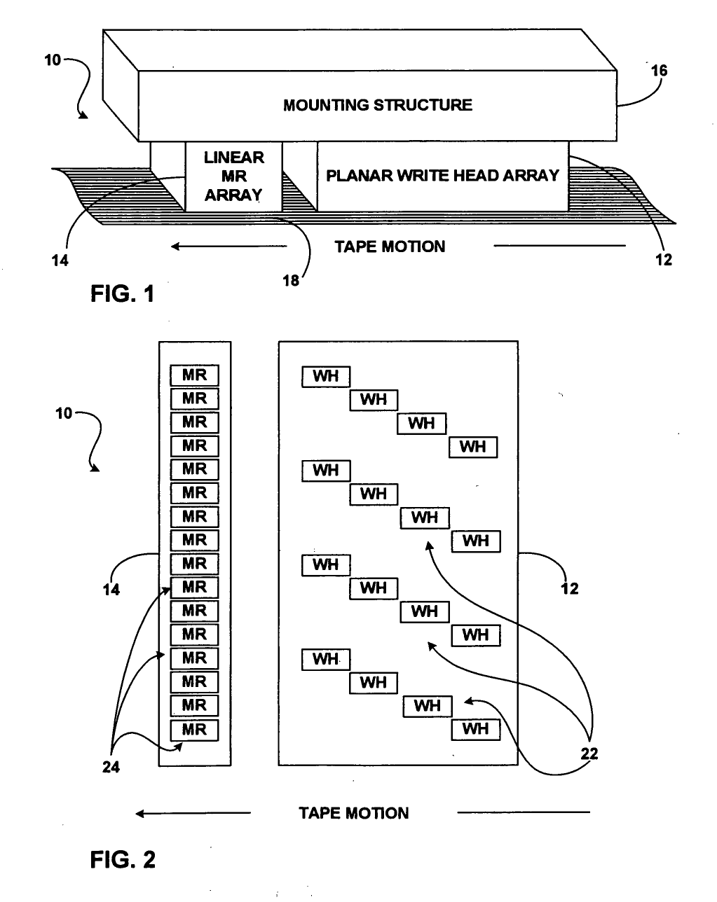

FIG. 1 is perspective view of a system 10 comprising a linear array of magnetoresistive (MR) heads 14 and a planar array of write heads 12. In the FIGS, individual magnetoresistive heads are abbreviated (MR) and individual write heads are abbreviated (WH). Linear array of MR heads 14 and planar array of write heads 12 may be precisely mounted into a mounting structure 16 in order to ensure that the channels of linear array 14 align with the channels of planar array. For example, microscopes or optical alignment techniques may be used in order to ensure channel alignment between arrays 12 and 14. Alternatively, separate mounting structures or actuators may be used for array 12 and array 14. In that case, servo tracking could be-performed independently for each array.

Magnetic tape 18 can feed past planar array 12 of write heads and data can be written to different tracks of magnetic tape 18 via the different write heads of planar array 12. Each write head defines a channel of planar array 12, with each channel corresponding to a unique track on magnetic tape 18. Each MR head in the linear array 14 also defines a channel. Each channel defined by a write head and a corresponding MR head align with a track on magnetic tape 18. Thus, each track on magnetic tape 18 can be written by a unique write head of planar array 12 and read by a unique MR head of linear array 14. One or more of the write heads of planar array 12 may also function as an inductive read element used for reading and tracking pre-written servo marks.

The tracks of magnetic tape 18 may be data tracks or servo tracks. Accordingly, the channels of planar array 12 may be used to record data or servo information, depending on the implementation of system 10. Linear array of MR heads 14 can simultaneously read information stored in the different tracks of magnetic tape 18. Magnetic tape 18 can feed past linear array of MR heads 14 and data can be read from the different tracks of magnetic tape 18 via the different MR heads of linear array 14. Like the channels of planar array 12, the channels of linear array 14 may be used to read data or servo information. In some cases, linear array 14 can be used independently of planar array 12, e.g., during readout of pre-recorded data. In other cases, linear array 14 may be used to read and verify information as it is recorded by planar array 12.

FIG. 2 is a bottom view of system 10 illustrating planar array 12 of write heads and linear array 14 of MR heads. In particular, planar array 12 comprises a set of write heads 22 arranged in a two-dimensional matrix, wherein each of the write heads defines a write channel for system 10. In other examples, however, a two-dimensional matrix of write heads could be non-planar.

Linear array 14 comprises a set of magnetoresistive (MR) heads 24 arranged in a linear configuration. Importantly, each of write heads 22 substantially align with a corresponding one of MR heads 24. Thus, system 10 includes a same number of write heads 22 and MR heads 24. Although sixteen MR heads 24 and sixteen write heads 22 are illustrated, system 10 may include any number of MR heads 24 and a corresponding number of write heads 22.

Conventionally, track pitch reduction in magnetic tape systems has been limited by difficulties in reducing the spacing between write heads in a linear array of write heads. In particular, the pitch of the excitation coil of write heads has generally resulted in track pitch limits in conventional magnetic writing devices. In order to address such track pitch limitations, the invention provides for a planar array 12 of write heads 22 arranged in a two-dimensional matrix. Accordingly, channel pitches of adjacent write heads 22 are not limited by the pitch of the excitation coils. In some cases, the excitation coil of write heads 22 can be coiled into a direction perpendicular to the plane of planar array 12 so as to further avoid conventional track pitch limitations. Moreover, an array of write heads with excitation coils perpendicular to the plane of the array can also be formed in an integrated circuit. In any case, planar array 12 is used with a linear array of MR heads 14. For example, a linear array of MR heads 14 may comprise a conventional configuration of MR heads because the track pitch spacing concerns are not as prevalent for linear arrays of MR heads.

Another problem with track pitch reductions results from dimensional instability of flexible magnetic media. In particular, flexible magnetic media can pose substantial problems to track pitch reductions because changes to the media dimensions can cause changes between the locations of tracks before and after the tracks are written. The matrix arrangement of write heads described herein addresses these problems by avoiding limits imposed by head coils, and by including a large number of head channels so that the dimensional changes to the medium are allocated across a large number of tracks. Therefore, the system described herein can facilitate read and write operations at very small track pitches.

Each of write heads 22 substantially align with a corresponding one of MR heads 24. In this manner, each channel of system 10 includes a unique one of write heads 22 and a corresponding unique one of read heads 24. Each channel corresponds to a track on the medium to be recorded, e.g., a data track or servo track on magnetic tape. In accordance with the invention, the track pitch (and head channel pitch) can be made less than 100 microns, less than 50 microns, or even less than 10 microns. Although channel pitches on this order are generally achievable with a linear array of M heads, channel pitches on this order are generally not achievable with a linear array of write heads that include excitation coils. To achieve such channel pitches for the write heads, a planar array is generally needed. For this reason, the invention incorporates a linear array of MR heads with a planar array of write heads to facilitate a read/write system that can operate at improved track pitches relative to conventional read/write systems.

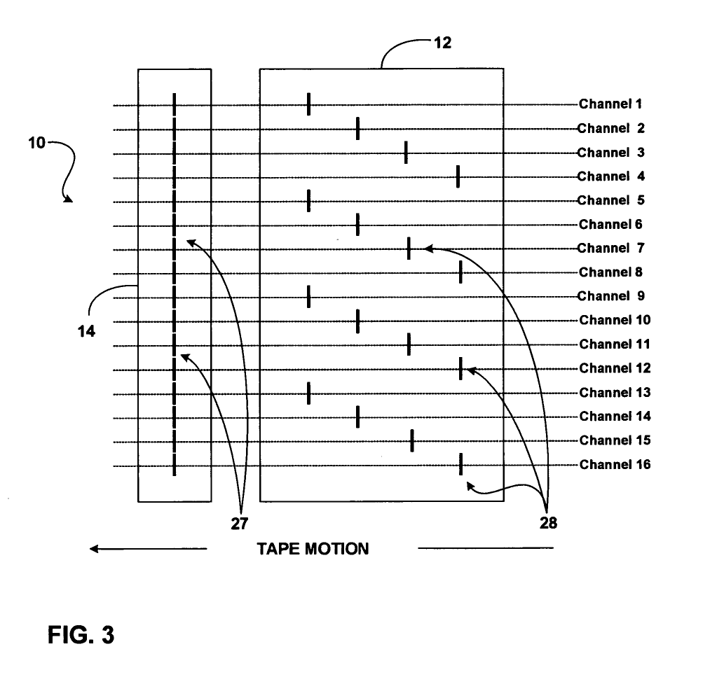

FIG. 3 is another bottom view rendition of system 10 comprising planar array 12 of write heads and linear array 14 of read heads. In the illustration of FIG. 3, planar array 12 comprises a set of write heads which are illustrated as write gaps arranged in a two-dimensional matrix. Again, each of the write heads (or write gaps) defines a write channel for system 10. Sixteen channels are labeled on FIG. 3.

Linear array 14 comprises a set of magnetoresistive (MR) heads which are illustrated in FIG. 3 as gaps 27 arranged in a linear configuration. Importantly, each of write heads 22 substantially align with a corresponding one of MR heads 24. Thus system 10 includes a same number of write heads 22 and MR heads 24. Each channel can be viewed as being defined by a corresponding head of linear array 14, a corresponding head of planar array 12, or both. In any case, the invention incorporates a linear array 14 of MR heads with a planar array 12 of write heads to facilitate a system that can operate at improved track pitches relative to conventional read/write systems. Again, such track pitches may be less than 100 microns, less than 50 microns, or even less than 10 microns. At such track pitches, data storage densities of magnetic media can be enhanced, particularly for magnetic tape.

By way of example, planar array 12 of write heads may comprise a fully integrated matrix magnetic recording head with independent control such as that substantially described in U.S. patent Publication 2003/0011922, published Jan. 16, 2003 to Nozieres et al. Other configurations of planar array 12, however, may also be used. In FIG. 3, the write heads are illustrated as gaps 28 arranged in a planar matrix configuration, although non-planar matrix configurations could also be used.

Linear array 14 of MR heads may comprise a set of MR heads or giant magnetoresistive (GMR) heads arranged in a linear configuration. Each MR head of linear array 12 may include an MR sensor material that is resistively responsive to magnetic fields. When the magnetic field proximate the MR sensor material changes, the M head can detect such changes. In this manner, the MR heads utilize magnetic and resistive phenomena to facilitate detection of magnetically encoded in formation on a magnetic medium.

A linear array of MR heads may have advantages in terms of quality of readout and ease of manufacture, relative to magneto-optic read heads or other read heads. For this reason, the combination of a linear array of MR heads with a planar array of write heads can allow for read and write operations at improved track pitches relative to conventional systems, and also provide a read/write system at reduced costs relative to a system that uses magneto-optic heads for readout. MR heads may also have better reading sensitivity and improved signal-to-noise ratios relative to magneto-optic read heads or other types of read heads capable of operating at the small track pitches described herein. Accordingly, MR heads may be more reliable than magneto-optic heads or other read heads.

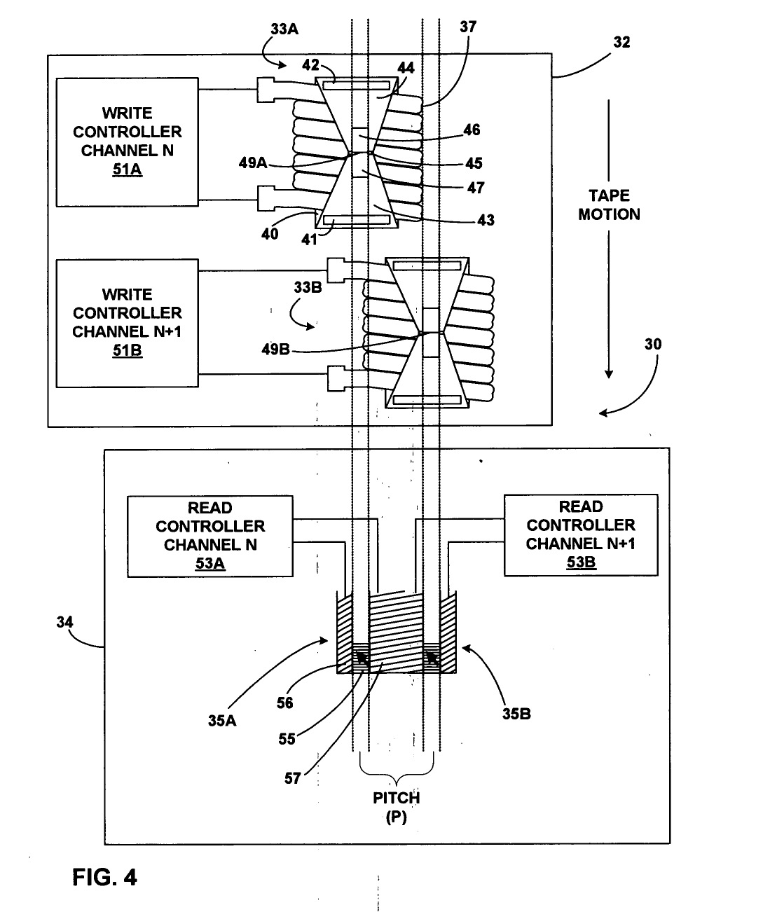

FIG. 4 is a block diagram of system 30 illustrating a portion of a planar array 32 of write heads and a portion of a linear array 34 of MR heads. In this case, only two channels of planar array 32 and a corresponding two channels of linear array 34 are illustrated. For example, a first channel is defined by first write head 33A and first MR head 35A, and a second channel is defined by second write head 33B and second MR head 35B.

Write heads 33A and 33B are substantially similar but separated by a distance of one head channel pitch (P). In particular, the write gaps 49A and 49B of write heads 33A and 33B are separated by the head channel pitch (P). Write heads 33 will be described with reference to head 33A. Again, however, write head 33B is substantially similar to write head 33A.

Write head 33A comprises a magnetic circuit fabricated onto a non-magnetic substrate. Write head 33A includes an excitation coil 37 that coils in a direction perpendicular to the plane defined by planar array 32. This can help reduce the size of the array and also facilitate the matrix configuration in an integrated circuit.

In particular, excitation coil 37 wraps around a bottom pole piece 40. Bottom pole piece 40, two pillars 41, 42 and two concentrators 43, 44 are made of a magnetic material such as NiFe or another soft magnetic material. Concentrators 43, 44 are interrupted so as to define a gap 45. On top of gap 45 are additional pole pieces 46, 47 formed of a high saturation magnetization material that can prevent detrimental saturation of the poles when data is being written. For example, pole pieces 46, 47 may comprise sputtered FeTaN/TaN multilayers or plated FeCoNi, FeCoCr or NiFe. Pole pieces 46, 47 define write gap 49A used for writing magnetic signals to the magnetic medium. Head 33A can be formed by thin film deposition and patterning techniques generally known in the art. Additional details of exemplary write heads 33 can be found in U.S. patent Publication 2003/0011922.

Write heads 33 are separately controllable via write controllers 51A and 51B. Accordingly, signals can be written to adjacent tracks on a magnetic medium using write heads 33. Importantly, the illustrated configuration of write heads 33 allows for head channel pitch, and thus track pitches that are less than 100 microns, less than 50 microns, and even less than 10 microns. Moreover, write heads 33 may also function as an inductive read element used for reading and tracking pre-written servo marks.

MR heads 35A and 35B may comprise any type of MR read heads, including giant magnetoresistive (GMR) heads. MR heads 35A and 35B may be arranged in a linear configuration. MR heads 35A and 35B are substantially similar but separated by a distance of one head channel pitch (P). MR heads 35 will be described with reference to head 35A.

MR head 35A includes a magnetoresistive sensor material 55 separated by conductive materials 56 and 57. Magnetoresistive sensor material 55 may comprise NiFe or any other material that exhibits properties in which the material resistance is responsive to magnetic fields. In other words, the resistance of sensor material 55 changes as a function of the magnetic field in close proximity to material 55. Thus, a track of magnetic tape can be passed under magnetoresistive sensor material 55 and magnetic changes in the track will affect the resistance of material 55. By way of example, conductive materials 56, 57 may comprise Au or any other suitably conductive material.

Read controller 53A provides either constant voltage or constant current across conductive materials 56 and 57. Read controller 53A then measures changes in voltage or current, e.g., according to Ohm's Law, in order to identify changes in the resistance of material 55. In this manner, magnetic changes recorded on a track of magnetic tape can be detected by MR head 35A.

MR heads 35A and 35B are separately controllable via read controllers 53A and 53B. Accordingly, signals can be read from adjacent tracks on a magnetic medium using MR heads 35. In any case, the illustrated configuration of MR heads 35, or variations thereof, allow for head channel pitch, and thus track pitches that are less than 100 microns, less than 50 microns, and even less than 10 microns. Accordingly, MR heads 35 can be used with a planar array of write heads 33 to define a read write system functional at track pitches that are less than 100 microns, less than 50 microns, and even less than 10 microns.

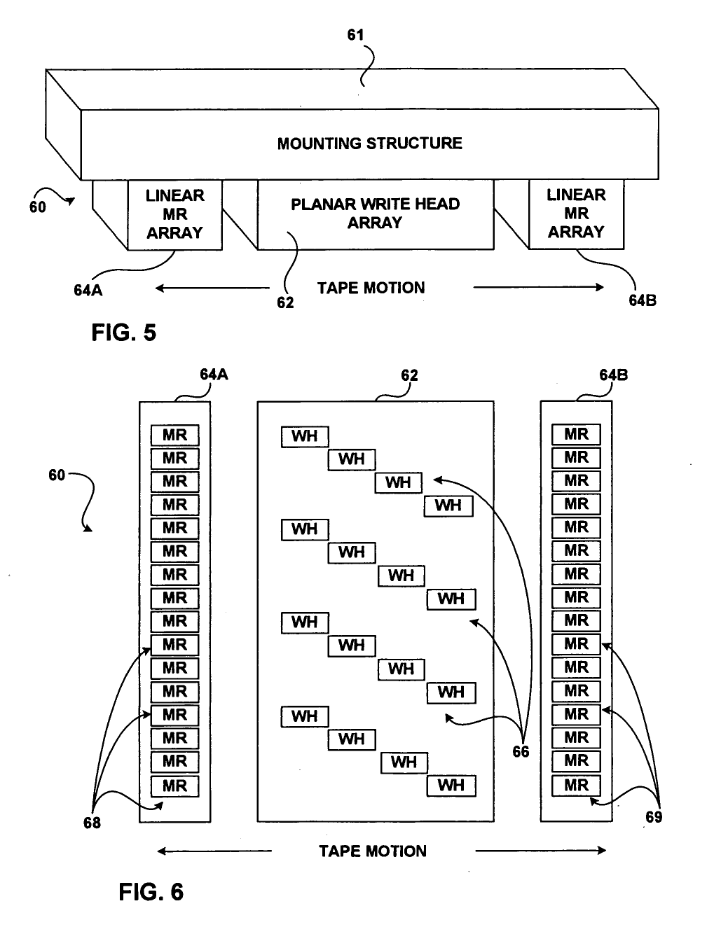

FIG. 5 is a perspective view of a system 60 comprising a first linear array of MR heads 64A, a second linear array of MR heads 64B, and a planar array of write heads 62 positioned between the first and second linear arrays of M heads 64A and 64B. Arrays 62, 64A and 64B can be mounted and aligned in mounting structure 61, e.g., using microscopes or other optical alignment techniques in order to ensure channel alignment between arrays 62, 64A and 64B. Alternatively, separate mounting structures or actuators may be used for the different arrays, and servo tracking could be performed independently for each array.

As illustrated, system 60 allows for read/write operations to occur regardless of the motion of the magnetic tape. For example, if the tape moves right-to-left, then the channels of planar array 62 can write data and the channels of first linear array 64A can read and verify the data written by the channels of planar array 62.

Alternatively, if the magnetic tape moves left-to-right, then the channels of planar array 62 can write data and the channels of second linear array 64B can read and verify the data written by the channels of planar array 62. Accordingly, system 60 allows for write and verify operations to be performed regardless of the direction of tape motion relative to system 60.

FIG. 6 is a bottom view of system 60 illustrating planar array 62 of write heads and first and second linear arrays 64A and 64B of MR heads. In particular, planar array 62 comprises a set of write heads 66 arranged in a two-dimensional matrix, wherein each of the write heads defines a write channel for system 60 regardless of the direction of tape motion. First linear array 64A comprises a set of MR heads 68 arranged in a linear configuration to define read channels when the tape moves in a first direction relative to system 60. Second linear array 64B comprises a set of MR heads 69 arranged in a linear configuration to define read channels when the tape moves in a second direction relative to system 60. Thus, when the tape moves in a first direction (right-to-left), planar array 62 is used to write data and first linear array 64A is used to read or verify the data, and when the tape moves in a second direction (left-to-right), planar array 62 is used to write data and second linear array 64B is used to read or verify the data.

Importantly, each of write heads 66 substantially align with a corresponding one of MR heads 68 of first linear array 64A and corresponding one of MR heads 69 of second linear array 64B. Thus, each of arrays 62, 64A and 64B include a same number of heads. Again, although sixteen MR heads 68, sixteen MR heads 69, and sixteen write heads 66 are illustrated, system 60 may include any number heads in each of the respective arrays.

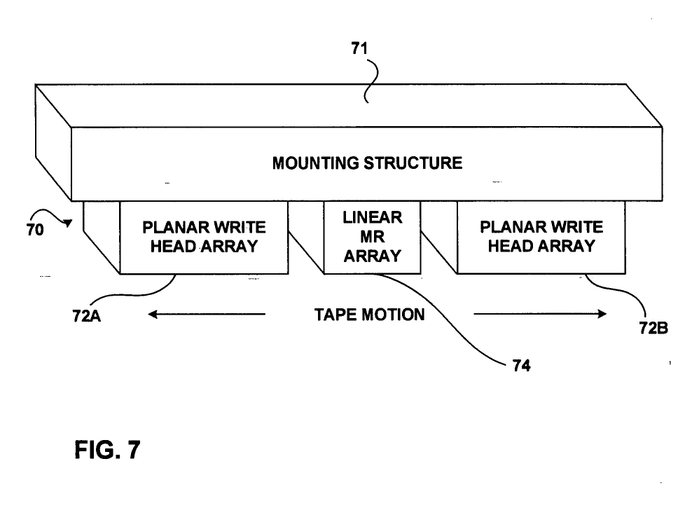

FIG. 7 is a perspective view of a system 70 comprising a first planar array of write heads 72A, a second planar array of write heads 72B, and a linear array of MR heads 74 positioned between the first and second planar arrays of write heads 72A and 72B. Arrays 72A, 72B and 74 can be mounted and aligned in mounting structure 71, e.g., using microscopes or other optical alignment techniques in order to ensure channel alignment between arrays 72A, 72B and 74. Alternatively, separate mounting structures or actuators may be used for the different arrays, and servo tracking could be performed independently for each array.

Like system 60, system 70 of FIG. 7 allows for read/write operations to occur regardless of the motion of the magnetic tape. For example, if the tape moves left-to-right, then the channels of first planar array 72A can write data and the channels of linear array 74 can read and verify the data written by the channels of first planar array 72A.

Alternatively, if the magnetic tape moves right-to-left, then the channels of second planar array 72B can write data and the channels of linear array 74 can read and verify the data written by the channels of second planar array 72B. Accordingly, system 70 is another configuration which allows for write and verify operations to be performed regardless of the direction tape motion relative to system 70.

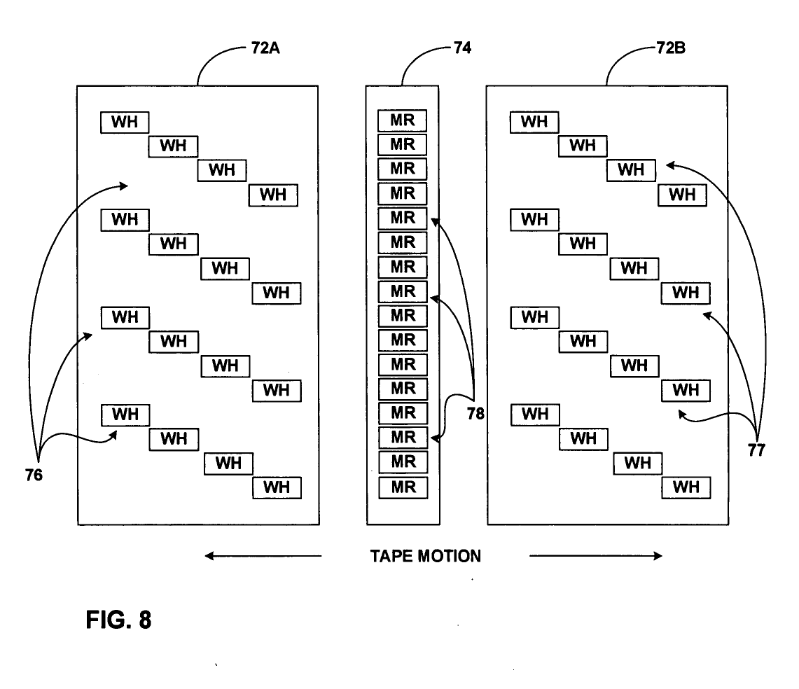

FIG. 8 is a bottom view of system 70 illustrating linear array 74 of MR heads and first and second planar arrays 72A and 72B of write heads. In particular, first planar array 72A comprises a set of write heads 76 arranged in a two-dimensional matrix, wherein each of the write heads defines a write channel for system 70 when the magnetic tape moves in a first tape direction relative to system 70. Second first planar array 72B comprises a set of write heads 77 arranged in another two-dimensional matrix, wherein each of the write heads defines a write channel for system 70 when the magnetic tape moves in a second tape direction relative to system 70.

Linear array 74 comprises a set of M heads 78 arranged in a linear configuration, wherein the channels of linear array 74 allow for read and verify operations to be performed when the magnetic tape moves in either the first or second tape directions. Thus, when the tape moves in a first direction (left-to-right), first planar array 72A is used to write data and linear array 74 is used to read or verify the data, and when the tape moves in a second direction (right-to-left), second planar array 72B is used to write data and linear array 74 is used to read or verify the data.

Again, each of write heads 76 of first planar array 72A substantially align with a corresponding one of MR heads 78 of linear array 74. Also, each of write heads 77 of second planar array 72B substantially align with a corresponding one of MR heads 78 of linear array 74. Thus, each of arrays 72A, 72B and 74 include a same number of heads. Again, although sixteen write heads 76, sixteen write heads 77, and sixteen MR heads 78 are illustrated, system 70 may include any number of heads in each of the respective arrays.

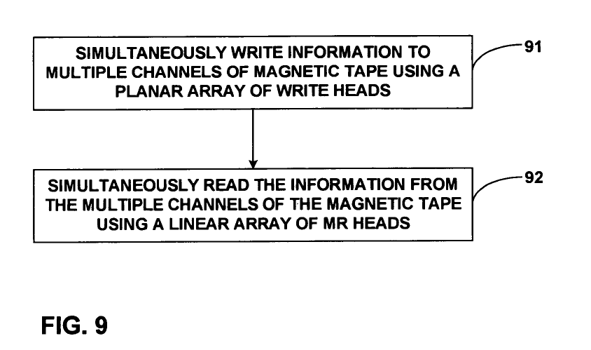

FIG. 9 is a flow diagram according to an embodiment of the invention. As shown in FIG. 9, system 10 simultaneously writes information to multiple channels of magnetic tape using a planar array 12 of write heads (91). System 10 then simultaneously reads the information from the multiple channels of the magnetic tape using a linear array 14 of MR heads (92). In this manner, linear array 14 can serve as a verification mechanism to ensure the integrity of any data written by planar array 12.

In another example, planar array 62 of system 60 simultaneously writes information to multiple channels of magnetic tape regardless of the direction that the tape feeds relative to system. In that case, first linear array 64A simultaneously reads the information from the multiple channels of the magnetic tape when the tape feeds in a first direction, and second linear array 64A simultaneously reads the information from the multiple channels of the magnetic tape when the tape feeds in a second direction. In this manner, bi-directional read/write operations can be performed, with planar array 62 performing the write operations for both directions, first linear array 64A performing the read or verify operations for a first tape direction and second linear array 64B performing the read or verify operations for a second tape direction.

In another example, planar array 72A of system 70 simultaneously writes information to multiple channels of magnetic tape when the tape feeds in a first direction, and planar array 72B simultaneously writes information to multiple channels of magnetic tape when the tape feeds in a second direction. In that case, linear array 64 simultaneously reads the information from the multiple channels of the magnetic tape regardless of whether the tape feeds in the first or second direction. In this manner, bi-directional read/write operations can be performed, with planar arrays 72A and 72B performing the write operations different directions and linear array 74 performing the read or verify operations for both tape directions.

Various embodiments of the invention have been described. For example, a system for recording data to magnetic media and reading data from such media has been described which utilizes a planar array of write heads and a linear array of MR heads. Nevertheless various modifications may be made. For example, the array of M heads may be a non-linear array or a planar array of M heads. Also, the write heads arranged in a two-dimensional matrix may be a planar array or a non-planar matrix array arranged in two or more planes.

Also, although many of the techniques have been described in the context of reading and writing data to data tracks, similar techniques may be used for writing or reading servo marks in servo tracks. Moreover, although many aspects of the invention have been described in the context of magnetic tape, other magnetic media may also be used with the read/write systems described herein. The techniques may be useful for longitudinal media for which the magnetic orientation of individual magnetic domains is generally parallel to the surface of the medium, or perpendicular media for which magnetic anisotropy is perpendicular to the plane of the medium. These and other embodiments are within the scope of the following claims.

1. A system for reading and writing information to magnetic media comprising:
an array of write heads arranged in a two-dimensional matrix, wherein each of the write heads defines a write channel for the system; and
an array of magnetoresistive (MR) heads, wherein each of the MR heads defines a read channel for the system.

2. The system of claim 1, wherein the array of MR heads comprises a linear array of MR heads and the array of write heads comprise a planar array of write heads.

3. The system of claim 1, wherein each of the write heads is substantially aligned with a corresponding one of the read heads such that each of the write channels substantially aligns with a corresponding one of the read channels.

4. The system of claim 3, wherein the write channels are separated by less than 100 microns and the read channels are separated by less than 100 microns.

5. The system of claim 4, wherein the write channels are separated by less than 50 microns and the read channels are separated by less than 50 microns.

6. The system of claim 5, wherein the write channels are separated by less than 10 microns and the read channels are separated by less than 10 microns.

7. The system of claim 1, wherein the MR heads comprise giant magnetoresistive (GMR) heads.

8. The system of claim 1, wherein a number of write heads in the array of write heads is the same as a number of M heads in the array of read heads.

9. The system of claim 1, wherein each of the write heads and each of the MR heads are independently controllable.

10. The system of claim 1, further comprising a write head controller for each of the write heads and an MR head controller for each of the MR heads.

11. The system of claim 1, wherein each write head includes an excitation coil which coils in a direction perpendicular to a plane defined by the planar array.

12. The system of claim 1, wherein at least one of the write heads also functions as an inductive read element that reads pre-written servo marks.

13. A system for reading and writing information to magnetic tape comprising:
a first array of write heads arranged in a two-dimensional matrix, wherein each of the write heads in the first array of write heads defines a write channel for the system in a first tape direction;
a second array of write heads arranged in another two-dimensional matrix, wherein each of the write heads in the second array of write heads defines a write channel for the system in a second tape direction;
an array of magnetoresistive (MR) heads positioned between the first and second arrays of write heads, wherein each of the MR heads of the array of MR heads defines a read channel for the system in both the first and second tape directions.

14. The system of claim 13, wherein the array of MR heads comprises a linear array of MR heads.

15. The system of claim 13, wherein each of the write heads of the first array of write heads is substantially aligned with a corresponding one of the read heads such that each write channel of the planar array of write heads substantially aligns with a corresponding read channel.

16. The system of claim 15, wherein each of the write heads of the second array of write heads is substantially aligned with a corresponding one of the read heads such that each write channel of the second array of write heads substantially aligns with a corresponding read channel.

17. The system of claim 13, wherein the write channels of both the first and second arrays of write heads are separated by less than 100 microns and the read channels of the array of read heads are separated by less than 100 microns.

18. A system for reading and writing information to magnetic tape comprising:
a first array of magnetoresistive (MR) heads, wherein each of the MR heads in the first array of MR heads defines a read channel for the system in a first tape direction;
a second array of MR heads, wherein each of the MR heads in the second array of M heads defines a read channel for the system in a second tape direction; and
an array of write heads arranged in a two-dimensional matrix and positioned between the first and second arrays of MR heads, wherein each of the write heads defines a write channel for the system in both the first and second tape directions.

19. The system of claim 18, wherein each of the write heads is substantially aligned with a corresponding one of the read heads in the first linear array such that each write channel substantially aligns with a corresponding read channel of the first linear array.

20. The system of claim 18, wherein the write channels of the array of write heads are separated by less than 100 microns and the read channels of both the first and second linear arrays are separated by less than 100 microns.
